(19) United States
(12) Patent Application Publication
(10) Pub. No.: US 2022/0266768 A1
(43) Pub. Date: Aug. 25, 2022

(54) VEHICULAR DENT GUARD DEVICE

(71) Applicant: Jennifer Rodriguez, Orlando, FL (US)

(72) Inventor: Jennifer Rodriguez, Orlando, FL (US)

(21) Appl. No.: 17/183,115

(22) Filed: Feb. 23, 2021

(51) Int. Cl. B60R 13/04

(52) U.S. Cl. CPC B60R 13/043

(57) ABSTRACT

A dent guard device for a vehicle door edge includes an elongated main body having an outside facing panel, an inside facing panel and a curved middle panel. The main body is constructed from an impact dampening and scratch reducing material, and a door clip is positioned along the inside surface of the curved middle panel. The door clip is constructed as a continuous component extending from the top of the main body to the bottom, and includes a semicircular central portion and a pair of resilient arms for engaging and receiving the edge of the vehicle door. The outside facing panel has a width that is greater than the width of the inside facing panel, and a plurality of magnets are positioned along or within both panel sections to secure the panels directly to the door body.

### TECHNICAL FIELD

The present invention relates generally to the automotive industry, and more particularly to a door-mounted device for preventing or reducing damage caused by impacts with secondary objects.

### BACKGROUND

The statements in this section merely provide background information related to the present disclosure and may not constitute prior art.

Whenever opening and closing the door of a vehicle, it is not uncommon for the outside edge of the door to accidentally make contact with an exterior object such as a parking post, a wall, or another vehicle, for example. Depending on the speed and force of the door movement at impact, it is possible to cause damage to one or both of the user's door and the exterior object.

For example, when the exterior object is the side of an adjacent vehicle, the damage caused to the vehicle's body panel can be much more extensive than the damage caused to the user's door itself. In some instances, this damage to the other vehicle body panel is such that it cannot be returned to its original condition without visiting an automotive body shop wherein expensive sheet metal and/or painting services must be performed.

Although many automobile manufacturers provide trim pieces that are positioned horizontally along door panels, these devices do not typically extend to the actual door edge, and thus do not reduce or eliminate damage caused by the door to other devices.

Accordingly, it would be beneficial to provide a vehicular dent guard device which can be secured along the edge of a vehicle door in order to overcome the drawbacks described above.

### SUMMARY OF THE INVENTION

The present invention is directed to a dent guard device for a vehicle door edge. One embodiment of the present invention can include an elongated main body having an outside facing panel, an inside facing panel and a curved middle panel. The main body can be constructed from an impact dampening and scratch reducing material, and a door clip can be positioned along the inside surface of the curved middle panel.

In one embodiment, the door clip can be constructed as a continuous component extending from the top of the main body to the bottom and can include a semicircular central portion and a pair of resilient arms for engaging and receiving the edge of the vehicle door.

In one embodiment, the outside facing panel can include a width that is greater than the width of the inside facing panel, and a plurality of magnets can be positioned along or within both panel sections to secure the panels directly to the door body.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a vehicle dent guard device, in accordance with one embodiment of the invention.

FIG. 2 is a cutout view of a vehicle door with the vehicle dent guard device installed thereon, in accordance with one embodiment of the invention.

FIG. 3 is a side view of a vehicle having a plurality of vehicle dent guard devices installed thereon, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “removably secured,” and derivatives thereof shall be used to describe a situation wherein two or more objects are joined together in a non-permanent manner so as to allow the same objects to be repeatedly joined and separated.

As described herein, the terms “connector” and “complementary connector” include any number of different elements that work together to repeatedly join two items together in a nonpermanent manner. Several nonlimiting examples include opposing strips of hook and loop material (i.e., Velcro®), attractively oriented magnetic elements, tethers, buckles, and compression fittings such as hooks, snaps and buttons, for example. Each illustrated connector and complementary connector can be permanently secured to the illustrated portion of the device via a permanent sealer such as glue, adhesive tape, or stitching, for example.

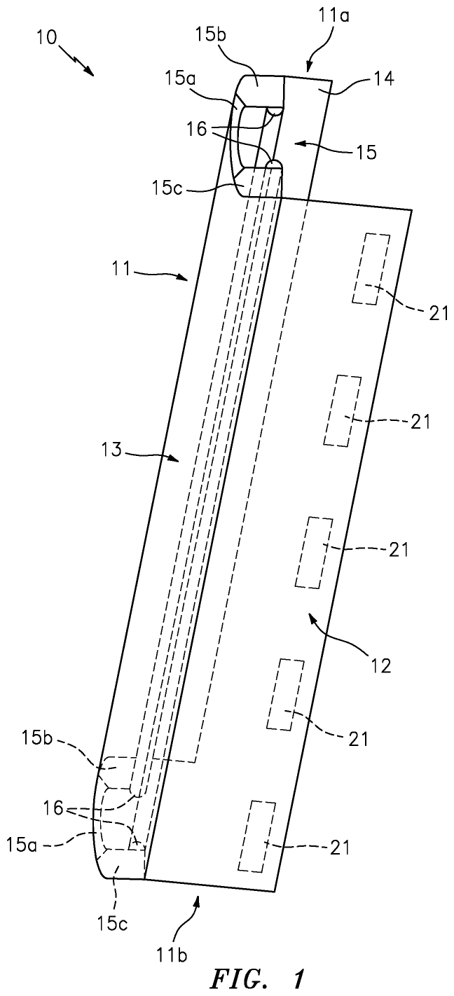

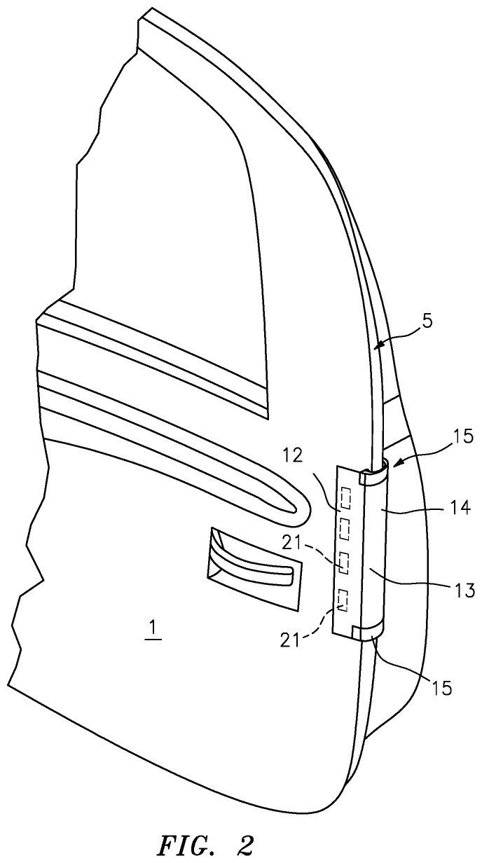

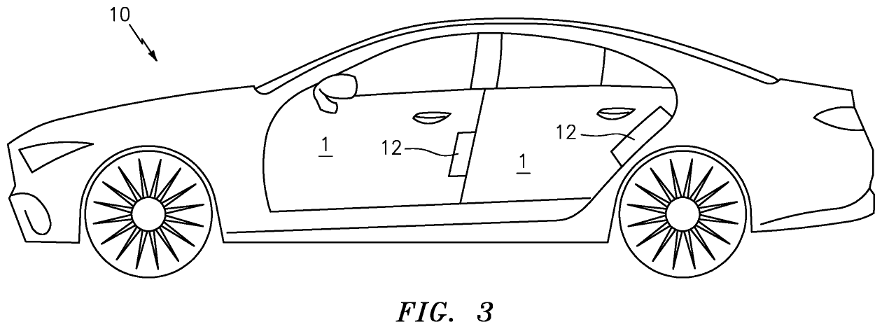

FIGS. 1-3 illustrate one embodiment of a vehicular dent guard device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in the drawings, the device 10 can include an elongated generally rectangular-shaped main body 11 that is folded to have an outside facing panel 12, an edge panel 13 and an inside facing panel 14. In the preferred embodiment, the main body can be constructed from one or more pieces of impact dampening and scratch reducing material, such as rubber, foam, or various plastics, for example.

Of course, any number of other impact dampening and scratch reducing materials are also contemplated. As defined herein, an impact resistant material can include any material that has the ability to fold, bend and/or be compressed so as to absorb impactive forces thereto in the manner described below. Likewise, as defined herein, a scratch reducing material can include any material having a nonabrasive outer surface that is smooth, so as to be able to move over a painted surface without scratching or otherwise removing paint from the surface.

In one embodiment, a door clip 15 can be secured along the inside surface of the edge panel 13, so as to receive and engage the outer edge of a vehicle door. In the preferred embodiment, the door clip can include a generally C-shaped member having a semicircular base portion 15a with legs 15b and 15c extending outward therefrom. In one embodiment, the distal ends of the legs 15b and 15c can include protrusions 16 constructed from or coated with a high friction material that are oriented toward each other.

In one embodiment, the door clip 15 can comprise a single, elongated component that extends from the top end of the main body 11a to the bottom end of the main body 11b. Because the main body is formed from a generally malleable material, the use of a continuous clipping mechanism 15 that is not vertically compressible functions to prevent the main body from sagging or bunching, when secured onto the vehicle door.

In the preferred embodiment, the arms 15b and 15c of the door clip 15 can be resilient in nature so as to move/flex toward and away from each other. Accordingly, when the outer edge 5 of a door panel 1 makes contact with the distal ends of the arms 15b-15c, the arms can separate to allow the door edge to continue to slide inward until making contact with the semicircular base portion 15a. When so positioned, the high friction protrusions 16 can function to maintain the clip 15 onto the door so as to prevent or reduce the likelihood of inadvertent separation.

In this regard, the clip 15 will preferably be constructed from a single piece of resilient material that is, for example, relatively strong for its weight. Several nonlimiting examples include but are not limited to various metals or metal alloys, various plastic/polymers, and/or various composite materials, for example. As described herein, the terms “high friction” and “nonskid” are used interchangeably to describe the ability of a material to prevent or resist being moved when in contact with a metal surface. Several nonlimiting examples of high friction materials include rubber, silicone and vinyl, for example. Of course, any number of other materials are also contemplated.

Although described above with regard to a particular shaped and sized clip, this is for illustrative purposes only. To this end, and number of other connectors can be used in conjunction with, or in place of the above-described clip in order to secure the main body onto a vehicle door panel in a removable manner.

In one embodiment, one or more magnets 21 can be provided along or within the main body 11. Each of the magnets 21 can function to magnetically attract the main body to the vehicle door panel 1. Because the main body is formed from a generally malleable material, the use of a plurality of magnetic elements along the outside facing panel 12, and the inside facing panel 14 advantageously functions as a secondary door attachment mechanism for preventing the panels from moving, sagging or bunching, when secured onto the vehicle door.

Although dimensions are not critical, the preferred embodiment of the inventive concepts contemplates the main body having a height (e.g., distance between top end 11a and bottom end 11b) of between 10-24 inches, and the outside facing panel 12 including a width (e.g., extending perpendicular to the main body height) of approximately 1 to 6 inches, for example. Of course, any number of other dimensions are also contemplated.

Accordingly, the above-described vehicular dent guard device 10 advantageously functions to provide an impact dampening and scratch reducing material along the outer edge of a vehicle door so as to prevent or reduce damage caused by the motion of the door when making contact with a secondary object.

As described herein, one or more elements of the device 10 can be secured together utilizing any number of known attachment means such as, for example, glue and compression fittings, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as casting, or molding, or through the use of singular pieces of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A dent guard device for a vehicle door edge, said device comprising:
an elongated main body having an outside facing panel, an inside facing panel and a curved middle panel;
a door clip that is positioned along an inside surface of the curved middle panel, said door clip including a semicircular central portion and a pair of arms;
wherein the door clip includes functionality for engaging an outer edge of a vehicle door and for positioning the outside facing panel along the vehicle door orthogonally.

2. The device of claim 1, wherein the elongated main body is constructed from an impact absorbent material.

3. The device of claim 2, wherein the main body is constructed from rubber.

4. The device of claim 1, wherein the elongated main body is constructed from a scratch reducing material.

5. The device of claim 4, wherein the main body is constructed from rubber.

6. The device of claim 1, wherein the clip includes a resilient construction.

7. The device of claim 1, wherein the clip is constructed from a single piece of resilient material.

8. The device of claim 7, wherein the clip is constructed from metal.

9. The device of claim 7, wherein the clip is constructed from plastic.

10. The device of claim 7, wherein the clip is constructed from a composite material.

11. The device of claim 7, further comprising:
a pair of protrusions that are disposed along a distal end of each of the pair of arms of the clip.
